(19) United States
(12) Patent Application Publication
(10) Pub. No.: US 2025/0349852 A1
(43) Pub. Date: Nov. 13, 2025

(54) SECONDARY BATTERY

(71) Applicant: MURATA MANUFACTURING CO., LTD., Kyoto (JP)

(72) Inventors: Daisuke MORI, Kyoto (JP); Ryuhei MATSUMOTO, Kyoto (JP); Yoshiaki SUZUKI, Kyoto (JP); Yuri NAKAYAMA, Kyoto (JP)

(21) Appl. No.: 19/279,120

(22) Filed: Jul. 24, 2025

Related U.S. Application Data
(63) Continuation of application No. PCT/JP2024/017587, filed on May 13, 2024.

(30) Foreign Application Priority Data
Jun. 13, 2023 (JP) 2023-096693

(51) Int. Cl. H01M 4/60; H01M 4/02; H01M 4/46; H01M 10/0569

(52) U.S. Cl. CPC H01M 4/608; H01M 4/466; H01M 10/0569; H01M 2004/027; H01M 2004/028

(57) ABSTRACT

Provided is a secondary battery that makes it possible to achieve a superior battery characteristic. The secondary battery includes a positive electrode, a negative electrode, and an electrolytic solution. The positive electrode includes a sulfur-containing polymer compound. The negative electrode includes a magnesium-containing material. The electrolytic solution includes an electrolyte salt. The sulfur-containing polymer compound includes carbon, nitrogen, and sulfur as constituent elements, and includes a carbon-nitrogen bond and a carbon-sulfur bond. The electrolyte salt includes a magnesium ion and a lithium ion as cations, and includes a halogen ion as an anion.

### CROSS REFERENCE TO RELATED APPLICATIONS

The present application is a continuation of International Application No. PCT/JP2024/017587, filed on May 13, 2024, which claims priority to Japanese Patent Application No. 2023-096693, filed on Jun. 13, 2023, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution. A configuration of the secondary battery has been considered in various ways.

Specifically, a positive electrode includes sulfur, a negative electrode includes magnesium metal, and an electrolytic solution includes lithium chloride. In addition, a positive electrode includes a sulfur copolymer, and a negative electrode includes magnesium metal.

### SUMMARY

The present technology relates to a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is desirable to provide a secondary battery that makes it possible to achieve a superior battery characteristic.

A secondary battery according to one embodiment of the present technology includes a positive electrode, a negative electrode, and an electrolytic solution. The positive electrode includes a sulfur-containing polymer compound. The negative electrode includes a magnesium-containing material. The electrolytic solution includes an electrolyte salt. The sulfur-containing polymer compound includes carbon, nitrogen, and sulfur as constituent elements, and includes a carbon-nitrogen bond and a carbon-sulfur bond. The electrolyte salt includes a magnesium ion and a lithium ion as cations, and includes a halogen ion as an anion.

Here, the term “sulfur-containing polymer compound” is a generic term for a polymer compound that includes carbon, nitrogen, and sulfur as constituent elements and includes a carbon-nitrogen bond and a carbon-sulfur bond, as described above. The term “magnesium-containing material” is a generic term for a material including magnesium as a constituent element. Details of a configuration of the sulfur-containing polymer compound and a configuration of the magnesium-containing material will be described later.

According to the secondary battery of one embodiment of the present technology, the positive electrode includes the sulfur-containing polymer compound. The negative electrode includes the magnesium-containing material. The electrolytic solution includes the electrolyte salt. The sulfur-containing polymer compound includes carbon, nitrogen, and sulfur as the constituent elements, and includes the carbon-nitrogen bond and the carbon-sulfur bond. The electrolyte salt includes the magnesium ion and the lithium ion as the cations, and includes the halogen ion as the anion. This makes it possible to achieve a superior battery characteristic.

Note that effects of the present technology are not necessarily limited to those described above and may include any of a series of effects described below in relation to the present technology.

### BRIEF DESCRIPTION OF THE FIGURES

FIG. 1 is a perspective diagram illustrating a configuration of a secondary battery according to one embodiment of the present technology.

FIG. 2 is a sectional diagram illustrating, in an enlarged manner, a configuration of a battery device illustrated in FIG. 1.

FIG. 3 is a sectional diagram illustrating a configuration of a test secondary battery.

### DETAILED DESCRIPTION

The present technology is described below in further detail including with reference to the drawings according to an embodiment.

A description is given first of a secondary battery according to an embodiment of the present technology.

In the secondary battery to be described here, charging and discharging reactions proceed by utilizing precipitation and dissolution of magnesium; accordingly, the secondary battery to be described here is a secondary battery in which a battery capacity is obtained through the charging and discharging reactions.

More specifically, the secondary battery includes a positive electrode that includes sulfur as a constituent element, and a negative electrode that includes magnesium as a constituent element, and is therefore what is called a magnesium-sulfur secondary battery.

In the magnesium-sulfur secondary battery, magnesium undergoes precipitation and dissolution in the negative electrode, and magnesium undergoes insertion and extraction in an ionic state in the positive electrode. Details of a configuration of the positive electrode and a configuration of the negative electrode will be described later.

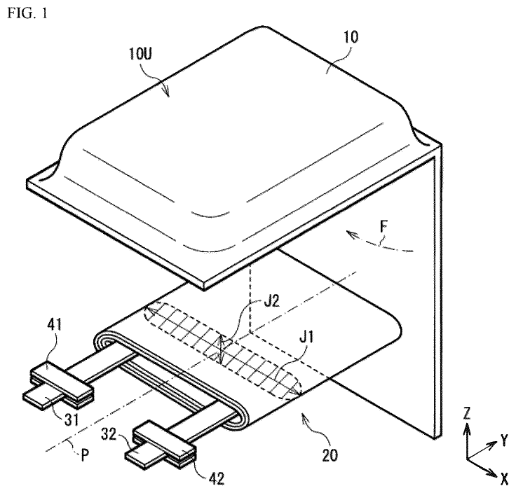

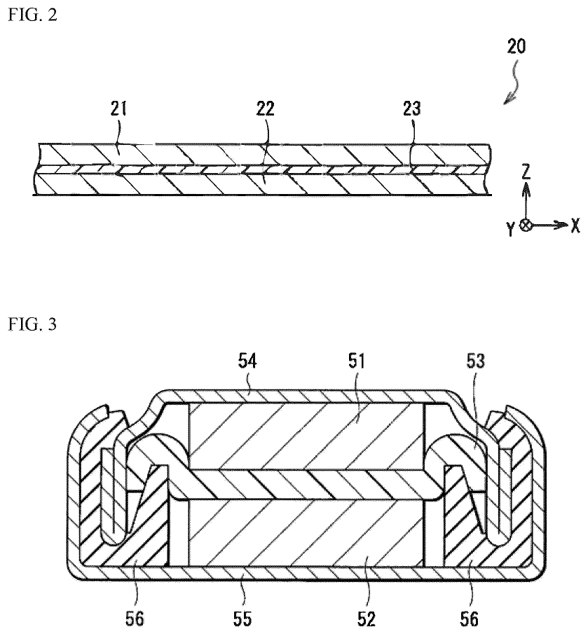

FIG. 1 illustrates a perspective configuration of the secondary battery. FIG. 2 illustrates, in an enlarged manner, a sectional configuration of a battery device 20 illustrated in FIG. 1. Note that FIG. 1 illustrates a state where an outer package film 10 and the battery device 20 are separated from each other, and illustrates a section of the battery device 20 along an XZ plane by a dashed line. FIG. 2 illustrates only a part of the battery device 20.

As illustrated in FIGS. 1 and 2, the secondary battery includes the outer package film 10, the battery device 20, a positive electrode lead 31, a negative electrode lead 32, and sealing films 41 and 42.

The secondary battery described here includes the outer package film 10 that is flexible or soft as an outer package member that is to contain the battery device 20 as described above. The secondary battery illustrated in FIGS. 1 and 2 is thus a secondary battery of what is called a laminated-film type.

As illustrated in FIG. 1, the outer package film 10 has a pouch-shaped structure that is sealed in a state where the battery device 20 is contained in the outer package film 10. The outer package film 10 thus contains a positive electrode 21, a negative electrode 22, a separator 23, and an electrolytic solution (not illustrated) that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The battery device 20 is contained in the outer package film 10. The battery device 20 is what is called a power generation device, and includes, as illustrated in FIGS. 1 and 2, the positive electrode 21, the negative electrode 22, the separator 23, and the electrolytic solution (not illustrated).

Here, the battery device 20 is what is called a wound electrode body. The positive electrode 21 and the negative electrode 22 are thus wound about a winding axis P, being opposed to each other with the separator 23 interposed therebetween. As illustrated in FIG. 1, the winding axis P is a virtual axis extending in a Y-axis direction.

The battery device 20 is not particularly limited in three-dimensional shape. Here, the battery device 20 has an elongated three-dimensional shape. Accordingly, a section of the battery device 20 intersecting the winding axis P, that is, the section of the battery device 20 along the XZ plane, has an elongated shape defined by a major axis J1 and a minor axis J2.

The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 includes a positive electrode active material into which magnesium is insertable in the ionic state and from which magnesium is extractable in the ionic state. The positive electrode active material includes any one or more of sulfur-containing polymer compounds. One reason for this is that this allows magnesium to be easily insertable and extractable in the ionic state into and from the positive electrode 21. This makes it easier for the charging and discharging reactions utilizing precipitation and dissolution of magnesium to proceed, as compared with when the positive electrode active material includes another material, such as a simple substance of sulfur or a compound of sulfur.

The sulfur-containing polymer compound includes sulfur as a constituent element. More specifically, the term “sulfur-containing polymer compound” is a generic term for a polymer compound that includes carbon, nitrogen, and sulfur as constituent elements and includes a carbon-nitrogen bond and a carbon-sulfur bond, as described above.

The carbon-nitrogen bond is what is called a covalent bond between carbon and nitrogen, and the sulfur-containing polymer compound includes multiple carbon-nitrogen bonds. Similarly, the carbon-sulfur bond is what is called a covalent bond between carbon and sulfur, and the sulfur-containing polymer compound includes multiple carbon-sulfur bonds.

The sulfur-containing polymer compound is not particularly limited in configuration, as long as the sulfur-containing polymer compound includes carbon, nitrogen, and sulfur as the constituent elements and includes the carbon-nitrogen bond and the carbon-sulfur bond.

A portion, of the sulfur-containing polymer compound, including the carbon-nitrogen bond may have a chain structure or a cyclic structure. Similarly, a portion, of the sulfur-containing polymer compound, including the carbon-sulfur bond may have a chain structure or a cyclic structure. Note that the chain structure may be a straight-chain structure or a branched structure.

Specifically, the sulfur-containing polymer compound includes a first cyclic part, a second cyclic part, and a coupling part. The first cyclic part and the second cyclic part may have the same configuration or may have respective different configurations. The sulfur-containing polymer compound including the first cyclic part, the second cyclic part, and the coupling part is hereinafter referred to as a “first sulfur-containing polymer compound”.

The first cyclic part and the second cyclic part are separated from each other. The first cyclic part and the second cyclic part each include carbon and nitrogen as constituent elements. Note that the first cyclic part and the second cyclic part may each further include any one or more of other elements as one or more constituent elements. Examples of the other elements include hydrogen.

That is, the first cyclic part and the second cyclic part are each a heterocyclic compound including a nitrogen atom as a heteroatom, i.e., an atom other than a carbon atom and a hydrogen atom. The heterocyclic compound may be a three-membered ring, a four-membered ring, a five-membered ring, a six-membered ring, or a ring with seven or more members. The heterocyclic compound may be a heterocyclic aromatic compound or a heterocyclic aliphatic compound.

In particular, the heterocyclic compound is preferably the heterocyclic aromatic compound. One reason for this is that this makes it easier for multiple heterocyclic aromatic compounds to be polymerized with each other, and thus facilitates synthesis of the sulfur-containing compound with a sufficient molecular weight.

Specific examples of the heterocyclic aromatic compound include pyridine, which is a six-membered ring including one heteroatom (one nitrogen atom).

Note that the first sulfur-containing polymer compound may include multiple first cyclic parts, and the multiple first cyclic parts may be condensed to each other. Similarly, the first sulfur-containing polymer compound may include multiple second cyclic parts, and the multiple second cyclic parts may be condensed to each other. One reason for this is that this facilitates synthesis of the first sulfur-containing compound with a sufficient molecular weight.

The coupling part is a divalent group that is disposed between the first cyclic part and the second cyclic part and is coupled to each of the first cyclic part and the second cyclic part. The first cyclic part and the second cyclic part are thus coupled to each other via the coupling part. The coupling part includes sulfur as a constituent element. Note that the coupling part may further include any one or more of other elements as one or more constituent elements. Examples of the other elements include hydrogen, carbon, and nitrogen. Because the first cyclic part and the second cyclic part are separated from each other as described above, the coupling part is interposed between the first cyclic part and the second cyclic part.

In particular, the coupling part preferably includes only sulfur as a constituent element. One reason for this is that this facilitates sufficient insertion and extraction of magnesium in the ionic state into and from the first sulfur-containing polymer compound.

Specific examples of the coupling part include —Sₙ—, where n is an integer of 1 or greater. More specific examples of the coupling part include —S₂—(—S—S—) and —S₃—(—S—S—S—).

Note that, when the first sulfur-containing polymer compound includes the multiple first cyclic parts and the multiple second cyclic parts as described above, the first sulfur-containing polymer compound includes multiple coupling parts.

In this case, of multiple pairs of the first cyclic parts and the second cyclic parts, all the pairs of the first cyclic parts and the second cyclic parts may be coupled to each other via the corresponding coupling parts, or only one or more, but not all, of the pairs of the first cyclic parts and the second cyclic parts may be coupled to each other via the corresponding coupling parts.

The molecular weight of the first sulfur-containing polymer compound is not particularly limited, and may be set as desired. The molecular weight described here is what is called a weight average molecular weight.

Specific examples of the first sulfur-containing polymer compound include a polymer compound represented by Formula (1). One reason for this is that this facilitates sufficient insertion and extraction of magnesium in the ionic state into and from the positive electrode 21.

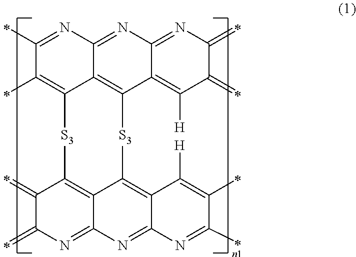

where:
n1 is an integer of 1 or greater; and
an asterisk (*) represents a dangling bond.

The polymer compound represented by Formula (1) has a configuration described below. Firstly, the first cyclic part (pyridine) and the second cyclic part (pyridine) are coupled to each other via the coupling part (—S₃—). Secondly, the multiple first cyclic parts are condensed to each other, the multiple second cyclic parts are condensed to each other, and the multiple coupling parts are present. Thirdly, of the multiple pairs of the first cyclic parts and the second cyclic parts, only one or more, but not all, of the pairs of the first cyclic parts and the second cyclic parts are coupled to each other via the corresponding coupling parts. Here, of three pairs of the first cyclic parts and the second cyclic parts, only two pairs of the first cyclic parts and the second cyclic parts are coupled to each other via the corresponding coupling parts.

Alternatively, the sulfur-containing polymer compound includes multiple cyclic parts and a coupling part. The multiple cyclic parts may have the same configuration or may have respective different configurations. Needless to say, only one or more, but not all, of the multiple cyclic parts may have the same configuration. The sulfur-containing polymer compound including the multiple cyclic parts and the coupling part is hereinafter referred to as a “second sulfur-containing polymer compound”.

The multiple cyclic parts are condensed to each other, and the multiple cyclic parts each include carbon and nitrogen as constituent elements. Note that the multiple cyclic parts may each further include any one or more of other elements as one or more constituent elements. Examples of the other elements include hydrogen.

That is, the multiple cyclic parts are each a heterocyclic compound including a nitrogen atom as a heteroatom, as with each of the first cyclic part and the second cyclic part described above. Details of the heterocyclic compound are as described above.

The coupling part has a configuration similar to that of the above-described coupling part except for what is described below.

The coupling part is coupled to any two cyclic parts out of the multiple cyclic parts, and includes sulfur as a constituent element. Because the multiple cyclic parts are condensed to each other as described above, the coupling part extends from any one cyclic part out of the multiple cyclic parts to another one cyclic part out of the multiple cyclic parts. The two cyclic parts to which the coupling part is coupled may be two cyclic parts that are adjacent to each other, or may be two cyclic parts that are not adjacent to each other.

Note that the number of coupling parts is not particularly limited, and the sulfur-containing polymer compound may include only one coupling part or multiple coupling parts.

The molecular weight of the second sulfur-containing polymer compound is not particularly limited, and may be set as desired. The molecular weight described here is what is called a weight average molecular weight.

Specific examples of the second sulfur-containing polymer compound include a polymer compound represented by Formula (2). One reason for this is that this facilitates sufficient insertion and extraction of magnesium in the ionic state into and from the positive electrode 21.

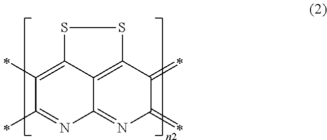

where:
n2 is an integer of 1 or greater; and
an asterisk (*) represents a dangling bond.

The polymer compound represented by Formula (2) has a configuration described below. Firstly, the multiple cyclic parts (pyridine) are condensed to each other, and the coupling part (—S—S—) is coupled to two cyclic parts out of the multiple cyclic parts. Secondly, the two cyclic parts to which the coupling part is coupled are adjacent to each other.

Needless to say, the first sulfur-containing polymer compound may be a polymer compound other than the polymer compound represented by Formula (1). The second sulfur-containing polymer compound may be a polymer compound other than the polymer compound represented by Formula (2). Further, the sulfur-containing polymer compound may be a polymer compound other than the first sulfur-containing polymer compound and the second sulfur-containing polymer compound.

To check whether the positive electrode 21 includes the sulfur-containing polymer compound and to check a composition of the sulfur-containing polymer compound, the positive electrode 21 is analyzed by any one or more of analysis methods including, without limitation, infrared spectroscopy (IR), Raman spectroscopy, X-ray photoelectron spectroscopy (XPS), and X-ray absorption fine structure (XAFS) analysis.

Note that, although not specifically illustrated here, the positive electrode 21 may include a positive electrode current collector and a positive electrode active material layer.

The positive electrode current collector is an electrically conductive support that supports the positive electrode active material layer, and has two opposed surfaces on each of which the positive electrode active material layer is to be provided. The positive electrode current collector includes an electrically conductive material such as a metal material. Specific examples of the electrically conductive material include nickel.

The positive electrode active material layer is supported by the positive electrode current collector, and includes any one or more of sulfur-containing polymer compounds as the positive electrode active material. Note that the positive electrode active material layer may further include any one or more of other materials including, without limitation, a positive electrode binder and a positive electrode conductor.

The positive electrode active material layer may be provided on each of the two opposed surfaces of the positive electrode current collector, or may be provided only on one of the two opposed surfaces of the positive electrode current collector. A method of forming the positive electrode active material layer is not particularly limited, and specific examples thereof include a coating method.

The positive electrode binder includes any one or more of resin materials including, without limitation, a fluorine-based resin, a polyvinyl-alcohol-based resin, and a styrene-butadiene-copolymer rubber. Specific examples of the fluorine-based resin include polyvinylidene difluoride and polytetrafluoroethylene.

Note that the positive electrode binder may include an electrically conductive polymer compound. Specific examples of the electrically conductive polymer compound include polyaniline, polypyrrole, polythiophene, and a copolymer of two or more thereof. The electrically conductive polymer compound may be unsubstituted, or may be substituted with any one or more functional groups.

The positive electrode conductor includes any one or more of electrically conductive materials including, without limitation, a carbon material, a metal material, and an electrically conductive polymer compound.

Specific examples of the carbon material include graphite, a carbon fiber, carbon black, and a carbon nanotube. The graphite may be natural graphite or artificial graphite. Examples of the carbon fiber include a vapor grown carbon fiber (VGCF). Examples of the carbon black include acetylene black and Ketjen black. Examples of the carbon nanotube include a single-wall carbon nanotube (SWCNT) and a multi-wall carbon nanotube (MWCNT), and examples of the multi-wall carbon nanotube include a double-wall carbon nanotube (DWCNT). Specific examples of the metal material include nickel.

The negative electrode 22 includes any one or more of magnesium-containing materials as a negative electrode active material. One reason for this is that this makes it easier for the charging and discharging reactions utilizing precipitation and dissolution of magnesium to proceed.

The term “magnesium-containing material” is a generic term for a material including magnesium as a constituent element, as described above. That is, the magnesium-containing material may be a simple substance of magnesium (what is called magnesium metal), an alloy of magnesium, a compound of magnesium, or a mixture of two or more thereof. Note that purity of the magnesium metal is not particularly limited, and the magnesium metal may therefore include any amount of impurity.

One or more metal elements (excluding magnesium) to be included as one or more constituent elements in the alloy of magnesium may be any one or more of desired metal elements, and are not particularly limited in kind. Specific examples of the metal elements include lithium, aluminum, and zinc.

A content of magnesium in the alloy of magnesium is not particularly limited, and is specifically greater than or equal to 90 mol %. One reason for this is that this makes it easier for the charging and discharging reactions utilizing precipitation and dissolution of magnesium to proceed.

A content of lithium and a content of aluminum in the alloy of magnesium are not particularly limited, and are each specifically less than or equal to 10 mol %. A content of zinc in the alloy of magnesium is not particularly limited, and is specifically less than or equal to 2 mol %. One reason for this is that a voltage at the time of discharging is secured and a sufficient battery capacity is thus obtainable.

In particular, the magnesium-containing material preferably includes the magnesium metal. One reason for this is that this makes it easier for the charging and discharging reactions utilizing precipitation and dissolution of magnesium to proceed sufficiently.

A thickness of the negative electrode 22 is not particularly limited, and is specifically within a range from 1 μm to 50 μm both inclusive. One reason for this is that an energy density per volume improves.

The negative electrode 22 may have a configuration similar to that of the positive electrode 21. That is, although not specifically illustrated here, the negative electrode 22 may include a negative electrode current collector and a negative electrode active material layer.

The negative electrode current collector is an electrically conductive support that supports the negative electrode active material layer, and has two opposed surfaces on each of which the negative electrode active material layer is to be provided. The negative electrode current collector includes an electrically conductive material such as a metal material. Specific examples of the electrically conductive material include nickel.

The negative electrode active material layer is supported by the negative electrode current collector, and includes any one or more of magnesium-containing materials as the negative electrode active material. Note that the negative electrode active material layer may further include any one or more of other materials including, without limitation, a negative electrode binder and a negative electrode conductor.

The negative electrode active material layer may be provided on each of the two opposed surfaces of the negative electrode current collector, or may be provided only on one of the two opposed surfaces of the negative electrode current collector. A method of forming the negative electrode active material layer is not particularly limited, and specific examples thereof include a coating method.

Details of the negative electrode binder are similar to those of the positive electrode binder. Details of the negative electrode conductor are similar to those of the positive electrode conductor.

The separator 23 is an insulating porous film interposed between the positive electrode 21 and the negative electrode 22 as illustrated in FIG. 2, and allows magnesium to pass therethrough in the ionic state while preventing a short circuit between the positive electrode 21 and the negative electrode 22. The separator 23 includes any one or more of insulating polymer compounds. Specific examples of the insulating polymer compound include polyethylene.

The electrolytic solution is a liquid electrolyte. The positive electrode 21 and the separator 23 are each impregnated with the electrolytic solution. Note that the negative electrode 22 may further be impregnated with the electrolytic solution.

The electrolytic solution includes an electrolyte salt. Note that the electrolytic solution may further include a solvent, which is a medium that allows for dissolution and ionization of the electrolyte salt.

The electrolyte salt includes any one or more of metal salts each including a cation and an anion.

Specifically, the electrolyte salt includes a magnesium ion and a lithium ion as cations, and includes a halogen ion as an anion. That is, the electrolyte salt includes halogenated magnesium as a magnesium salt, and includes halogenated lithium as a lithium salt.

One reason why the electrolyte salt includes the magnesium ion and the lithium ion as the cations is that the voltage at the time of discharging increases as compared with when the electrolyte salt includes only the magnesium ion as the cation.

One reason why the electrolyte salt includes the halogen ion as the anion is that the voltage at the time of discharging increases as compared with when the electrolyte salt does not include the halogen ion as the anion.

Based upon the above, when the electrolyte salt includes the magnesium ion and the lithium ion as the cations and includes the halogen ion as the anion, the voltage at the time of discharging increases markedly. This makes it easier for the charging reaction utilizing precipitation and dissolution of magnesium to proceed smoothly, and a high battery capacity is thus obtainable.

The halogen ion is not particularly limited in kind. Specific examples of the halogen ion include a fluorine ion, a chlorine ion, a bromine ion, and an iodine ion.

In particular, it is preferable that the halogen ion include a chlorine ion and that the electrolyte salt thus include magnesium chloride (MgCl₂) and lithium chloride (LiCl). One reason for this is that the voltage at the time of discharging sufficiently increases and a sufficiently high battery capacity is thus obtainable.

The electrolytic solution may further include any one or more of other electrolyte salts. Note that the above-described electrolyte salt including the magnesium ion and the lithium ion as the cations and including the halogen ion as the anion is excluded from the other electrolyte salts described here.

One or more cations in the other electrolyte salt may be any one or more of positive ions (metal ions), and are not particularly limited in kind. One or more anions in the other electrolyte salt may be any one or more of negative ions, and are not particularly limited in kind.

Specific examples of the one or more anions in the other electrolyte salt include a perchloric acid ion, a nitric acid ion, a sulfuric acid ion, an acetic acid ion, a trifluoroacetic acid ion, a tetrafluoroboric acid ion, a tetraphenylboric acid ion, a hexafluorophosphic acid ion, a hexafluoroarsenic acid ion, a bis(hexamethyldisilazide) ion, a bis(trifluoromethanesulfonyl)imide ion, and a bis[tetra(hexafluoroisopropyl)]boric acid ion. Examples of the halogen ion include a fluorine ion, a chlorine ion, a bromine ion, and an iodine ion.

Specific examples of the other electrolyte salt include the following.

Specific examples of the other electrolyte salt that is the magnesium salt include magnesium perchlorate (Mg(ClO₄)₂), magnesium nitrate (Mg(NO₃)₂), magnesium sulfate (MgSO₄), magnesium acetate (Mg(CH₃COO)₂), magnesium trifluoroacetate (Mg(CF₃COO)₂), magnesium tetrafluoroborate (Mg(BF₄)₂), magnesium tetraphenylborate (Mg(B(C₆H₅)₄)₂), magnesium hexafluorophosphate (Mg(PF₆)₂), magnesium hexafluoroarsenate (Mg(AsF₆)₂), magnesium bis(hexamethyldisilazide) (Mg[N(Si(CH₃)₃)₂]₂), magnesium bis(trifluoromethanesulfonyl)imide (Mg[N(CF₃SO₂)₂]₂, and magnesium bis[tetra(hexafluoroisopropyl)]borate (Mg[B(OCH(CF₃)₂)₄]₂).

Specific examples of the other electrolyte salt that is the lithium salt include lithium perchlorate (LiClO₄), lithium nitrate (LiNO₃), lithium sulfate (Li₂SO₄), lithium acetate (LiCH₃COO), magnesium trifluoroacetate (LiCF₃COO), lithium tetrafluoroborate (LiBF₄), magnesium tetraphenylborate (Li(B(C₆H₅)₄), lithium hexafluorophosphate (LiPF₆), lithium hexafluoroarsenate (LiAsF₆), magnesium bis(hexamethyldisilazide) (Li[N(Si(CH₃)₃)₂]), magnesium bis(trifluoromethanesulfonyl)imide (Li[N(CF₃SO₂)₂, and lithium bis[tetra(hexafluoroisopropyl)]borate (Li[B(OCH(CF₃)₂)₄).

When the electrolyte salt includes another negative ion together with the chlorine ion as the anions, a content of the chlorine ion in the anions is not particularly limited. In particular, the content of the chlorine ion in the anions is preferably greater than or equal to 20 mol %. One reason for this is that the voltage at the time of discharging sufficiently increases and a sufficiently high battery capacity is thus obtainable.

A content (mol/l (=mol/dm³)) of the electrolyte salt in the electrolytic solution is not particularly limited, and may be set as desired. Note that the content of the electrolyte salt described here refers to the content of the electrolyte salt with respect to the solvent.

The solvent includes any one or more of non-aqueous solvents (organic solvents). The electrolytic solution including the one or more non-aqueous solvents is what is called a non-aqueous electrolytic solution.

The non-aqueous solvent is not particularly limited in kind, and preferably includes an ether compound, in particular. One reason for this is that this allows the electrolyte salt to be easily dissolved in the ether compound, and a state of the electrolytic solution is thus stabilized.

The term “ether compound” is a generic term for a compound including an ether bond (—O—). The ether compound may have a chain structure or a cyclic structure. The chain structure may be a straight-chain structure or a branched structure. The number of ether bonds may be one, or two or more.

Specific examples of the ether compound include dimethoxyethane, diethylene glycol dimethyl ether, tetraethylene glycol dimethyl ether, and tetrahydrofuran.

As illustrated in FIGS. 1 and 2, the positive electrode lead 31 is a positive electrode wiring coupled to the positive electrode 21, and is led to an outside of the outer package film 10. Note that when the positive electrode 21 includes the positive electrode current collector, the positive electrode lead 31 is coupled to the positive electrode current collector. The positive electrode lead 31 includes an electrically conductive material such as a metal material. Specific examples of the electrically conductive material include aluminum. The positive electrode lead 31 has any one of shapes including, without limitation, a thin plate shape and a meshed shape.

As illustrated in FIGS. 1 and 2, the negative electrode lead 32 is a negative electrode wiring coupled to the negative electrode 22, and is led to the outside of the outer package film 10. Note that when the negative electrode 22 includes the negative electrode current collector, the negative electrode lead 32 is coupled to the negative electrode current collector. Here, the negative electrode lead 32 is led toward a direction similar to that in which the positive electrode lead 31 is led out. The negative electrode lead 32 includes an electrically conductive material such as a metal material. Specific examples of the electrically conductive material include copper. Note that details of a shape of the negative electrode lead 32 are similar to those of the shape of the positive electrode lead 31.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polymer compound include polypropylene.

The sealing film 42 has a configuration similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

The secondary battery operates as described below in the battery device 20.

Upon discharging the secondary battery, the negative electrode active material (the magnesium-containing material) is dissolved in the negative electrode 22, which causes magnesium to be eluted into the electrolytic solution, and the eluted magnesium is inserted into the positive electrode 21 in the ionic state. Upon charging the secondary battery, magnesium is extracted from the positive electrode active material (the sulfur-containing polymer compound) of the positive electrode 21 into the electrolytic solution in the ionic state, and the extracted magnesium is precipitated on the negative electrode 22.

To manufacture the secondary battery, the positive electrode 21 and the negative electrode 22 are each fabricated, and the electrolytic solution is prepared, following which the secondary battery is assembled using the positive electrode 21, the negative electrode 22, and the electrolytic solution, according to an example procedure to be described below.

A description is given below of a case where the magnesium metal is used as the magnesium-containing material.

First, the positive electrode active material (the sulfur-containing polymer compound), the positive electrode binder, and the positive electrode conductor are mixed with each other to thereby obtain a positive electrode mixture. Thereafter, the positive electrode mixture is shaped into layers using a molding machine to thereby form the positive electrode active material layers. Lastly, the positive electrode active material layers are pressure-bonded to the two respective opposed surfaces of the positive electrode current collector using a compression apparatus such as a molding machine or a roll pressing machine. In this manner, the positive electrode 21 is fabricated.

Thereafter, as the negative electrode 22, the negative electrode active material (the magnesium metal as the magnesium-containing material) is prepared. Used as the magnesium-containing material in this case is a magnesium foil.

The electrolyte salt is put into the solvent to thereby prepare the electrolytic solution.

First, the positive electrode lead 31 is coupled to the positive electrode current collector of the positive electrode 21 by a joining method such as a welding method, and the negative electrode lead 32 is coupled to the negative electrode 22 by the joining method such as the welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby form a wound body (not illustrated). Thereafter, the wound body is pressed using a compression apparatus such as a pressing machine to thereby shape the wound body into an elongated shape. The shaped wound body has a configuration similar to that of the battery device 20 except that the positive electrode 21, the negative electrode 22, and the separator 23 are each not impregnated with the electrolytic solution.

Thereafter, the wound body is placed in the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained in the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by the bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution, and the battery device 20 that is a wound electrode body is thus fabricated. Accordingly, the battery device 20 is sealed in the outer package film 10 having the pouch shape. The secondary battery is thus completed.

According to the secondary battery, the positive electrode 21 includes the sulfur-containing polymer compound. The negative electrode 22 includes the magnesium-containing material. The electrolytic solution includes the electrolyte salt. The sulfur-containing polymer compound includes carbon, nitrogen, and sulfur as the constituent elements, and includes the carbon-nitrogen bond and the carbon-sulfur bond. The electrolyte salt includes the magnesium ion and the lithium ion as the cations, and includes the halogen ion as the anion.

In this case, a series of kinds of action described below is achieved, as described above.

Firstly, because the positive electrode 21 includes the sulfur-containing polymer compound, magnesium is easily insertable and extractable in the ionic state into and from the positive electrode 21. This makes it easier for the charging and discharging reactions utilizing precipitation and dissolution of magnesium to proceed, as compared with when the positive electrode 21 includes another material, such as a simple substance of sulfur or a compound of sulfur.

More specifically, when the positive electrode 21 includes the simple substance of sulfur, sulfur is easily eluted from the positive electrode 21 into the electrolytic solution. This causes a side reaction between sulfur eluted into the electrolytic solution and the negative electrode 22, which tends to hinder the charging and discharging reactions utilizing precipitation and dissolution of magnesium. In contrast, when the positive electrode 21 includes the sulfur-containing polymer compound, sulfur is prevented from being easily eluted from the positive electrode 21 into the electrolytic solution. This prevents the side reaction described above, and thus makes it easier for the charging and discharging reactions utilizing precipitation and dissolution of magnesium to proceed stably.

Secondly, because the negative electrode 22 includes the magnesium-containing material, it becomes further easier for the charging and discharging reactions utilizing precipitation and dissolution of magnesium to proceed.

Thirdly, because the electrolyte salt includes the magnesium ion and the lithium ion as the cations, the voltage at the time of discharging increases as compared with when the electrolyte salt includes only the magnesium ion as the cation.

Fourthly, because the electrolyte salt includes the halogen ion as the anion, the voltage at the time of discharging further increases as compared with when the electrolyte salt does not include the halogen ion as the anion.

Accordingly, when the electrolyte salt includes the magnesium ion and the lithium ion as the cations and includes the halogen ion as the anion, the voltage at the time of discharging increases markedly. This makes it easier for the charging reaction utilizing precipitation and dissolution of magnesium to proceed smoothly, and a high battery capacity is thus obtainable.

Based upon the above, it becomes easier for the charging and discharging reactions utilizing precipitation and dissolution of magnesium to proceed sufficiently and stably, which makes it possible to achieve a superior battery characteristic.

In particular, the sulfur-containing polymer compound may include the first cyclic part, the second cyclic part, and the coupling part. The first cyclic part and the second cyclic part may each include carbon and nitrogen as the constituent elements. The coupling part may include sulfur as the constituent element. Such a sulfur-containing polymer compound corresponds to the first sulfur-containing polymer compound. This configuration facilitates sufficient insertion and extraction of magnesium in the ionic state into and from the positive electrode 21. Accordingly, it is possible to achieve higher effects.

In this case, the sulfur-containing polymer compound may include the multiple first cyclic parts, the multiple second cyclic parts, and the multiple coupling parts. The multiple first cyclic parts may be condensed to each other. The multiple second cyclic parts may be condensed to each other. This facilitates synthesis of the sulfur-containing compound with a sufficient molecular weight. Accordingly, it is possible to achieve even higher effects.

More specifically, the sulfur-containing compound may include the polymer compound represented by Formula (1). This facilitates sufficient insertion and extraction of magnesium in the ionic state into and from the positive electrode 21. Accordingly, it is possible to achieve even higher effects.

Further, the sulfur-containing polymer compound may include the multiple cyclic parts and the coupling part. The multiple cyclic parts may each include carbon and nitrogen as the constituent elements. The coupling part may include sulfur as the constituent element. Such a sulfur-containing polymer compound corresponds to the second sulfur-containing polymer compound. This configuration facilitates sufficient insertion and extraction of magnesium in the ionic state into and from the positive electrode 21. Accordingly, it is possible to achieve higher effects.

More specifically, the sulfur-containing compound may include the polymer compound represented by Formula (2). This facilitates sufficient insertion and extraction of magnesium in the ionic state into and from the positive electrode 21. Accordingly, it is possible to achieve even higher effects.

Further, the halogen ion may include the chlorine ion. This allows the voltage at the time of discharging to sufficiently increase. Accordingly, it is possible to achieve higher effects.

Further, the solvent of the electrolytic solution may include the ether compound. This allows the electrolyte salt to be easily dissolved in the ether compound. This therefore allows for stabilization of the state of the electrolytic solution. Accordingly, it is possible to achieve higher effects.

Further, the magnesium-containing material may include the magnesium metal. This makes it easier for the charging and discharging reactions utilizing precipitation and dissolution of magnesium to proceed sufficiently. Accordingly, it is possible to achieve higher effects.

Applications (application examples) of the secondary battery are not particularly limited. The secondary battery used as a power source may serve as a main power source or an auxiliary power source of, for example, electronic equipment or an electric vehicle. The main power source is preferentially used regardless of the presence of any other power source. The auxiliary power source may be used in place of the main power source, or may be switched from the main power source.

Specific examples of the applications of the secondary battery include electronic equipment, apparatuses for data storage, electric power tools, battery packs, medical electronic equipment, electric vehicles, and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. The battery pack is to be mounted on, for example, electronic equipment. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, only one secondary battery may be used, or two or more secondary batteries may be used.

The battery packs may each include a battery cell, or may each include an assembled battery. The electric vehicle is a vehicle that travels with the secondary battery as a driving power source, and may be a hybrid automobile that is additionally provided with a driving source other than the secondary battery. In the electric power storage system for home use, electric power accumulated in the secondary battery serving as an electric power storage source may be utilized for using, for example, home appliances.

### EXAMPLES

A description is given of Examples of the present technology according to an embodiment.

Electrolytic solutions and secondary batteries were manufactured, following which the electrolytic solutions were each evaluated for a physical property and the secondary batteries were each evaluated for a battery characteristic as described below.

### Example 1 and Comparative Examples 1 to 3

Secondary batteries were manufactured, following which the secondary batteries were each evaluated for a battery characteristic, in accordance with the following procedure.

### [Manufacturing of Secondary Battery]

Here, a test secondary battery was fabricated to conduct a simple evaluation as the evaluation for the battery characteristic. FIG. 3 illustrates a sectional configuration of the test secondary battery. The test secondary battery was a magnesium-sulfur secondary battery of a coin type.

In the following, a configuration of the test secondary battery is described, following which a procedure of manufacturing the test secondary battery is described.

### [Configuration of Test Secondary Battery]

As illustrated in FIG. 3, the test secondary battery included a test electrode 51, a counter electrode 52, a separator 53, an outer package cup 54, an outer package can 55, a gasket 56, and an electrolytic solution (not illustrated).

The test electrode 51 was placed in the outer package cup 54, and the counter electrode 52 was placed in the outer package can 55. The test electrode 51 and the counter electrode 52 were stacked on each other with the separator 53 interposed therebetween. The test electrode 51, the counter electrode 52, and the separator 53 were each impregnated with the electrolytic solution. The outer package cup 54 and the outer package can 55 were crimped to each other with the gasket 56 interposed therebetween. The test electrode 51, the counter electrode 52, and the separator 53 were each thus sealed in the outer package cup 54 and the outer package can 55.

### [Procedure of Manufacturing Test Secondary Battery]

The procedure of manufacturing the test secondary battery was as described below.

First, 10 parts by mass of the positive electrode active material (the sulfur-containing polymer compound), 30 parts by mass of the positive electrode binder (polytetrafluoroethylene available from AGC Inc.), and 60 parts by mass of the positive electrode conductor (Ketjen black, ECP600JD available from Lion Corporation) were mixed with each other to thereby obtain a positive electrode mixture.

Used as the sulfur-containing polymer compound was the compound represented by Formula (1) (SIP, sulfurized polyacrylonitrile available from Tokyo Chemical Industry Co., Ltd., in which a content of sulfur in the sulfur-containing polymer compound was 36 wt %) as the first sulfur-containing polymer compound.

Thereafter, the positive electrode mixture was shaped into a layer using a roll pressing machine to thereby form the positive electrode active material layer, following which the positive electrode active material layer was punched into a disk shape (having a diameter of 15 mm).

Lastly, the positive electrode active material layer was overlaid on one of the two opposed surfaces of the positive electrode current collector having a disk shape (having a diameter of 15 mm), following which the positive electrode active material layer was pressure-bonded to the positive electrode current collector using a molding machine. As a result, the test electrode 51 (a content of sulfur in the test electrode 51 was 10 wt %) was fabricated.

Note that the test electrode 51 for comparison was fabricated by a similar procedure except that a simple substance of sulfur (S₈) was used instead of the sulfur-containing polymer compound.

Thereafter, a magnesium foil (having a thickness of 200 μm) was prepared as the negative electrode active material (the magnesium metal as the magnesium-containing material), following which the negative electrode active material was punched into a disk shape (having a diameter of 16 mm). In this manner, the counter electrode 52 was fabricated.

Thereafter, the electrolyte salt was added to the solvent, following which the solvent was stirred. The electrolytic solution was thus prepared.

Used as the solvent was tetrahydrofuran (TH, available from Tomiyama Pure Chemical Industries, Ltd.) as the ether compound.

Used as the electrolyte salt was magnesium chloride (MgCl₂, available from Sigma-Aldrich Co. LLC) as the halogenated magnesium and lithium chloride (LiCl, available from Sigma-Aldrich Co. LLC) as the halogenated lithium.

As for the content of the electrolyte salt in the electrolytic solution, a content of magnesium chloride was set to 1 mol/l (=1 mol/dm³) with respect to the solvent, and a content of lithium chloride was set to 1 mol/l (=1 mol/dm³) with respect to the solvent.

Note that an electrolytic solution for comparison was prepared by a similar procedure, except that only magnesium chloride was used as the electrolyte salt without using lithium chloride. As for the content of the electrolyte salt in the electrolytic solution, the content of magnesium chloride was set to 2 mol/l (=2 mol/dm³) with respect to the solvent.

In addition, an electrolytic solution for comparison was prepared by a similar procedure, except that magnesium bis(trifluoromethanesulfonyl)imide (MgTFSI₂) as the other electrolyte salt was used instead of lithium chloride as the electrolyte salt. As for the content of the electrolyte salt in the electrolytic solution, the content of magnesium chloride was set to 0.4 mol/l (=0.4 mol/dm³) with respect to the solvent. As for a content of the other electrolyte salt in the electrolytic solution, a content of magnesium bis(trifluoromethanesulfonyl)imide was set to 0.4 mol/l (=0.4 mol/dm³) with respect to the solvent.

In this case, one reason why diethylene glycol dimethyl ether was used as the solvent instead of tetrahydrofuran was that magnesium bis(trifluoromethanesulfonyl)imide did not dissolve unless diethylene glycol dimethyl ether was used.

Details of combinations of the solvent and the electrolyte salt were as listed in Table 1.

After the preparation of the electrolytic solution, the electrolytic solution was analyzed by inductively coupled plasma (ICP) optical emission spectroscopy. As a result, it was confirmed that the content of the electrolyte salt and the content of the other electrolyte salt were each as described above.

Thereafter, the test electrode 51 was placed in the outer package cup 54, and the counter electrode 52 was placed in the outer package can 55. Thereafter, the test electrode 51 placed in the outer package cup 54 and the counter electrode 52 placed in the outer package can 55 were stacked on each other with the separator 53 (a glass fiber having a thickness of 200 μm, GC50 available from Advantech Corporation) impregnated with the electrolytic solution being interposed between the test electrode 51 and the counter electrode 52. In this case, the test electrode 51 was so disposed that the positive electrode active material layer was opposed to the counter electrode 52 with the separator 53 interposed therebetween. Lastly, the outer package cup 54 and the outer package can 55 were crimped to each other with the gasket 56 interposed therebetween in a state where the test electrode 51 and the counter electrode 52 were stacked on each other with the separator 53 interposed therebetween. The test electrode 51 and the counter electrode 52 were thereby sealed in the outer package cup 54 and the outer package can 55. The test secondary battery was thus completed.

### [Evaluation of Battery Characteristic]

The test secondary batteries were each evaluated for a charge and discharge characteristic as the battery characteristic. The evaluation revealed the results presented in Table 1.

To evaluate the charge and discharge characteristic, the test secondary battery was repeatedly charged and discharged in an ambient temperature environment (at a temperature of 25° C.) to thereby calculate the number of times of charging and discharging (cycles) as an index for evaluating the charge and discharge characteristic. The number of times of charging and discharging was the number of times the test secondary battery was able to be charged and discharged with the battery capacity obtained.

Note that, upon discharging, the test secondary battery was discharged with a constant current of 0.5 mA until a voltage reached 0.1 V, and upon charging, the test secondary battery was charged with a constant current of 0.5 mA until the voltage reached 2.4 V.

TABLE 1

| | Positive | Negative | | | Number of |
|---|---|---|---|---|---|
| | electrode | electrode | Electrolytic solution | | times of |
| | Positive | Negative | | Electrolyte | charging |
| | electrode | electrode | | salt Other | and dis- |
| | active | active | | electrolyte | charging |
| | material | material | Solvent | salt | (cycles) |
| Example 1 | SIP | Magnesium | THF | MgCl₂ + | 32 |
| | | metal | | LiCl | |
| Comparative | S₈ | Magnesium | THF | MgCl₂ + | 0 |
| example 1 | | metal | | LiCl | |
| Comparative | SIP | Magnesium | THF | MgCl₂ | 0 |
| example 2 | | metal | | | |
| Comparative | SIP | Magnesium | DGDE | MgCl₂ + | 0 |
| example 3 | | metal | | MgTFSI₂ | |

As indicated in Table 1, the number of times of charging and discharging when the counter electrode 52 included the magnesium-containing material varied depending on the configuration of the test electrode 51 and the configuration of the electrolytic solution.

Specifically, when the electrolytic solution included magnesium chloride and lithium chloride as the electrolyte salt but the test electrode 51 included the simple substance of sulfur, i.e., in Comparative example 1, the number of times of charging and discharging was 0 cycles, and charging and discharging was not able to be performed in the first place.

When the test electrode 51 included the sulfur-containing polymer compound but the electrolytic solution included only magnesium chloride as the electrolyte salt, i.e., in Comparative example 2 also, the number of times of charging and discharging was 0 cycles, and charging and discharging was not able to be performed in the first place.

When the test electrode 51 included the sulfur-containing polymer compound but the electrolytic solution included magnesium chloride as the electrolyte salt and magnesium bis(trifluoromethanesulfonyl)imide as the other electrolyte salt, i.e., in Comparative example 3 also, the number of times of charging and discharging was 0 cycles, and charging and discharging was not able to be performed in the first place.

In contrast, when the test electrode 51 included the sulfur-containing polymer compound and the electrolytic solution included magnesium chloride and lithium chloride as the electrolyte salt, i.e., in Example 1, the number of times of charging and discharging was 32 cycles, and charging and discharging was able to be performed.

In this case, a series of tendencies described below were obtained, in particular. Firstly, when the first sulfur-containing polymer compound was used as the sulfur-containing polymer compound, the number of times of charging and discharging sufficiently increased. In this case, similar tendencies are expected to be obtained also by using the second sulfur-containing polymer compound as the sulfur-containing polymer compound. Secondly, when the electrolyte salt included the chlorine ion as the anion (the halogen ion), the number of times of charging and discharging sufficiently increased. Thirdly, when the solvent included the ether compound, a sufficient number of times of charging and discharging was obtained. Fourthly, when the magnesium-containing material included the magnesium metal, a sufficient number of times of charging and discharging was obtained.

Based upon the results presented in Table 1, when: the positive electrode 21 included the sulfur-containing polymer compound; the negative electrode included the magnesium-containing material; and the electrolyte salt of the electrolytic solution included the magnesium ion and the lithium ion as the cations and included the halogen ion as the anion, the number of times of charging and discharging increased. The charge and discharge characteristic was thus improved. Accordingly, it was possible to achieve a superior battery characteristic.

Although the present technology has been described above with reference to some embodiments and Examples, the configuration of the present technology is not limited to those described with reference to the embodiments and Examples above, and is therefore modifiable in a variety of ways.

Specifically, the description has been given of the case where the secondary battery has a battery structure of the laminated-film type or the coin type. However, the battery structure of the secondary battery is not particularly limited, and may be, for example, of a cylindrical type, a prismatic type, or a button type.

Further, the description has been given of the case where the battery device has a device structure of a wound type. However, the device structure of the battery device is not particularly limited, and the device structure may be, for example, a stacked type or a zigzag folded type. In the stacked type, the positive electrode and the negative electrode are stacked on each other. In the zigzag folded type, the positive electrode and the negative electrode are folded in a zigzag manner.

The effects described herein are mere examples, and effects of the present technology are therefore not limited to those described herein. Accordingly, the present technology may achieve any other effect.

Note that the present technology may have any of the following configurations according to an embodiment.

<1>

A secondary battery including:
a positive electrode including a sulfur-containing polymer compound;
a negative electrode including a magnesium-containing material; and
an electrolytic solution including an electrolyte salt, in which
the sulfur-containing polymer compound includes carbon, nitrogen, and sulfur as constituent elements, and includes a carbon-nitrogen bond and a carbon-sulfur bond, and
the electrolyte salt includes a magnesium ion and a lithium ion as cations, and includes a halogen ion as an anion.
   <2>

The secondary battery according to <1>, in which
the sulfur-containing polymer compound includes
   a first cyclic part and a second cyclic part that are separated from each other, and
   a coupling part that is disposed between the first cyclic part and the second cyclic part and is coupled to each of the first cyclic part and the second cyclic part,
the first cyclic part and the second cyclic part each include carbon and nitrogen as constituent elements, and
the coupling part includes sulfur as a constituent element.
   <3>

The secondary battery according to <2>, in which
the sulfur-containing polymer compound includes a plurality of the first cyclic parts, a plurality of the second cyclic parts, and a plurality of the coupling parts,
the first cyclic parts are condensed to each other, and
the second cyclic parts are condensed to each other.
   <4>

The secondary battery according to <2> or <3>, in which
the sulfur-containing polymer compound includes a compound represented by Formula (1),

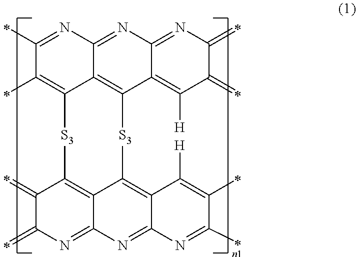

where
n1 is an integer of 1 or greater.
   <5>

The secondary battery according to <1>, in which
the sulfur-containing polymer compound includes
   multiple cyclic parts condensed to each other, and
   a coupling part coupled to any two cyclic parts out of the multiple cyclic parts,
the multiple cyclic parts each include carbon and nitrogen as constituent elements, and
the coupling part includes sulfur as a constituent element.
   <6>

The secondary battery according to <5>, in which
the sulfur-containing polymer compound includes a compound represented by Formula (2)

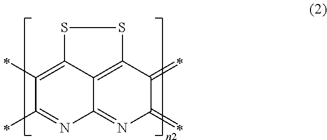

where
n2 is an integer of 1 or greater.
   <7>

The secondary battery according to any one of <1> to <6>, in which
the halogen ion includes a chlorine ion.
   <8>

The secondary battery according to any one of <1> to <7>, in which
the electrolytic solution includes a solvent, and
the solvent includes an ether compound.
   <9>

The secondary battery according to any one of <1> to <8>, in which
the magnesium-containing material includes a simple substance of magnesium.

### REFERENCE SIGNS LIST

21 . . . positive electrode
22 . . . negative electrode

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode including a sulfur-containing polymer compound;
a negative electrode including a magnesium-containing material; and
an electrolytic solution including an electrolyte salt, wherein
the sulfur-containing polymer compound includes carbon, nitrogen, and sulfur as constituent elements, and includes a carbon-nitrogen bond and a carbon-sulfur bond, and
the electrolyte salt includes a magnesium ion and a lithium ion as cations, and includes a halogen ion as an anion.

2. The secondary battery according to claim 1, wherein
the sulfur-containing polymer compound includes
a first cyclic part and a second cyclic part that are separated from each other, and
a coupling part that is disposed between the first cyclic part and the second cyclic part and is coupled to each of the first cyclic part and the second cyclic part,
the first cyclic part and the second cyclic part each include carbon and nitrogen as constituent elements, and
the coupling part includes sulfur as a constituent element.

3. The secondary battery according to claim 2, wherein
the sulfur-containing polymer compound includes a plurality of the first cyclic parts, a plurality of the second cyclic parts, and a plurality of the coupling parts,
the first cyclic parts are condensed to each other, and
the second cyclic parts are condensed to each other.

4. The secondary battery according to claim 2, wherein
the sulfur-containing polymer compound includes a compound represented by Formula (1), 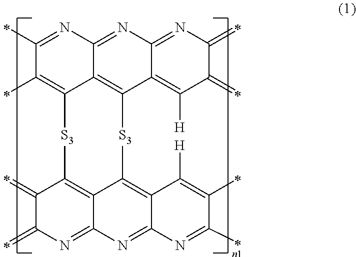
where
n1 is an integer of 1 or greater.

5. The secondary battery according to claim 1, wherein
the sulfur-containing polymer compound includes
multiple cyclic parts condensed to each other, and
a coupling part coupled to any two cyclic parts out of the multiple cyclic parts,
the multiple cyclic parts each include carbon and nitrogen as constituent elements, and
the coupling part includes sulfur as a constituent element.

6. The secondary battery according to claim 5, wherein
the sulfur-containing polymer compound includes a compound represented by Formula (2), 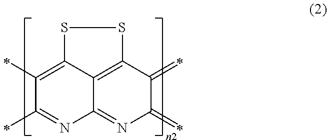
where
n2 is an integer of 1 or greater, and
n2 is an integer of 1 or greater.

7. The secondary battery according to claim 1, wherein
the halogen ion includes a chlorine ion.

8. The secondary battery according to claim 1, wherein
the electrolytic solution includes a solvent, and
the solvent includes an ether compound.

9. The secondary battery according to claim 1, wherein
the magnesium-containing material includes a simple substance of magnesium.
